(19) United States
(12) Patent Application Publication
(10) Pub. No.: US 2016/0229360 A1
(43) Pub. Date: Aug. 11, 2016

(54) WIRE ROUTING STRUCTURE

(71) Applicant: YAZAKI CORPORATION, Tokyo (JP)

(72) Inventor: Shigeki IIMURO, Shizuoka (JP)

(21) Appl. No.: 15/078,406

(22) Filed: Mar. 23, 2016

Related U.S. Application Data
(63) Continuation of application No. PCT/JP2014/074907, filed on Sep. 19, 2014.

(30) Foreign Application Priority Data
Sep. 30, 2013 (JP) 2013-203670

(51) Int. Cl. B60R 16/02; B60R 16/03; F16L 3/16; H02G 3/04

(52) U.S. Cl. CPC B60R 16/0215; H02G 3/04; B60R 16/03; F16L 3/16

(57) ABSTRACT

An object of the present invention is to provide a wire routing structure capable of improving a flex life of wires by securing a large degree of flex R of the wires which are displaced by movement of a slide door at all times. A wire routing structure is a wire routing structure for wires for supplying electric power to a slide door, including a turning support member which is provided to at least one of a vehicle and the slide door, and is designed to displaceably support the wires by turning in a horizontal plane, and, when the turning support member is provided to the vehicle, slide movement of the slide door from a closed position to an open position causes the turning support member to turn about a rotary shaft of the turning support member and to move closer to the open position than the rotary shaft.

### TECHNICAL FIELD

The present invention relates to a wire routing structure which routes wires which supply electric power to a slide door which is arranged slidably moveable towards a closed position at which an opening of a vehicle is fully closed and is arranged slidably moveable towards an open position at which the opening of the vehicle is fully opened.

### BACKGROUND ART

A power feeding device for a slide structure in which a wire harness is routed from a vehicle body of a vehicle to a slide door and which has flex durability of a wire harness enhanced by suppressing, for example, a flex of a wire harness portion close to the slide door when the slide door is opened or closed is disclosed (refer to, for example, Patent Literature 1).

As shown in FIG. 7, the power feeding device disclosed in Patent Literature 1 includes a power feeding tool 102 at a vehicle body D side of the vehicle, and a power feeding tool 103 at a slide door S side. Each of the power feeding tools 102 and 103 includes a harness exterior member 104 formed by connecting a plurality of bridge members 104A. A corrugate tube 105 of a wire harness is inserted and routed between the power feeding tools 102 and 103 through internal spaces of both of the harness exterior members 104. In this regard, FIG. 7 is a plan view that illustrates a state of a conventional power feeding device where a slide door is fully opened.

Each of the power feeding tools 102 and 103 includes an outer member 106 which is fixed to the slide door S or the vehicle body D, an inner member 107 which is pivotally supported by the outer member 106 turnably in a horizontal direction, and is made of synthetic resin, the harness exterior member 104 whose one end is connected to the inner member 107 and which is made of synthetic resin, and a stopper (not illustrated) which suppresses a flex of the harness exterior member 104 when the slide door S is fully opened. One end (other end) of the corrugate tube 105 is retained by the inner member 107 of the power feeding tool 102 at the vehicle body D side, and the other end (one end) is retained by the inner member 107 of the power feeding tool 103 at the slide door S side, so that the corrugate tube 105 is continuously routed between both of the inner members 107.

### CITATION LIST

### Patent Literature

Patent Literature 1: JP 2013-128369 A

### SUMMARY OF INVENTION

### Technical Problem

However, the conventional power feeding device 101 controls flexes of the harness exterior members 104 (i.e., wire harness portions) between both of the power feeding tools 102 and 103 by using the stoppers. However, as illustrated in FIG. 8, flexes of a displacement portion W1 of the wire harness (wires W) outside both of the power feeding tools 102 and 103 (the vehicle body D side) have not been taken into account. In this regard, FIG. 8 is a view that explains a problem of the present invention, and is a plan view that illustrates a state where the slide door makes slide movement from a closed position to an open position. In addition, in FIG. 8, a dotted line indicates that the slide door is provided at the closed position, and a solid line indicates that the slide door is provided at the open position.

For example, as illustrated in FIG. 8, in the conventional power feeding device 101, each inner member 107 (harness exterior member) which is provided at the vehicle body D side and turnably supports the wires W is formed in a cylindrical shape, and the wires W are inserted and routed towards the slide door S through a wire insertion port 107a at the vehicle body D side. A rotary shaft (shaft R) of each inner member 107 is provided above a center axis of the wires W inserted in each inner member 107. Hence, slide movement of the slide door S from a closed position S1 to an open position S2 turns each inner member 107 about the shaft R, and moves the wire insertion port 107a of each inner member 107 towards the closed position S1. Thus, the slide movement of the slide door S bends the displacement portion W1 of the wires W at a small degree of flex R, and therefore there is a problem that the displacement portion W1 of the wires W receives a load and is readily damaged.

An object of the present invention is to provide a wire routing structure which can improve a flex life of wires by securing a large degree of flex R of the wires which are displaced by movement of a slide door at all times.

### Solution to Problem

The present invention according to a first aspect is a wire routing structure for routing a wire that supplies electric power to a slide door arranged slidably movable towards a closed position at which an opening of a vehicle is fully closed, and is also arranged slidably movable towards an open position at which the opening of the vehicle is fully opened, the wire routing structure including: a turning support member which is provided to at least one of the vehicle and the slide door, and is designed to displaceably support the wire by turning in a horizontal plane, wherein, when the turning support member is provided to the vehicle, slide movement of the slide door from the closed position to the open position causes the turning support member to turn about a rotary shaft of the turning support member so as to move closer to the open position than the rotary shaft, while when the turning support member is provided to the slide door, the slide movement of the slide door from the closed position to the open position causes the turning support member to turn about the rotary shaft of the turning support member so as to move closer to the closed position than the rotary shaft.

A feature of the invention according to a second aspect is that, in the invention according to the first aspect, when the turning support member is provided to the vehicle and the slide door is provided at the closed position, the rotary shaft is provided at a position displaced towards the vehicle from a center axis of the wire supported by the turning support member, and when the turning support member is provided to the slide door and the slide door is provided at the closed position, the rotary shaft is provided at a position displaced towards the slide door from the center axis of the wire supported by the turning support member.

A feature of the invention according to a third aspect is that, in the invention according to the second aspect, when the turning support member is provided to the vehicle and the slide door is provided at the closed position, the rotary shaft is provided at an end of the turning support member at a side of the open position, and when the turning support member is provided to the slide door and the slide door is provided at the closed position, the rotary shaft is provided at an end of the turning support member at a side of the closed position.

A feature of the invention according to a fourth aspect is that, in the invention according to any one of the first aspect to the third aspect, the turning support member includes a guide which guides the rotary shaft along a slide direction of the slide door.

### Advantageous Effects of Invention

The invention according to the first aspect includes a turning support member which displaceably supports a wire, and, when the turning support member is provided to the vehicle, slide movement of the slide door from a closed position to an open position causes the turning support member to turn about a rotary shaft of the turning support member and to move closer to the open position than the rotary shaft, or, when the turning support member is provided to the slide door, slide movement of the slide door from the closed position to the open position causes the turning support member to turn about the rotary shaft of the turning support member and to move closer to the closed position than the rotary shaft. Thus, when, for example, the turning support member is provided to the vehicle, the slide movement of the slide door from the closed position to the open position causes an opening (wire insertion port) of the turning support member distant from the slide door to move towards the open position. Consequently, the wire insertion port turns drawing a larger arc than a case where the opening moves towards the closed position, and it is possible to make larger the degree of flex R at the displacement portion of the wires (a portion closer to a vehicle side than the wire insertion port of the wires). Consequently, when the slide door makes slide movement, the wires can secure the large degree of flex R at all times and it is possible to improve a flex life of the wires. Further, the wires secure the large degree of flex R at all times, so that it is possible to reduce a displacement amount of the wires during movement of the slide door from the closed position to the open position and, consequently, to reduce a force for causing the slide movement of the slide door.

According to the invention according to the second aspect, when the turning support member is provided to the vehicle and the slide door is provided at the closed position, the rotary shaft is provided at a position displaced towards the vehicle from a center axis of the wire supported by the turning support member, and, when the turning support member is provided to the slide door and the slide door is provided at the closed position, the rotary shaft is provided at a position displaced towards the slide door from the center axis of the wire supported by the turning support member. Thus, when, for example, the turning support member is provided to the vehicle, the slide movement of the slide door from the closed position to the open position causes the wire insertion port of the turning support member to move towards the open position. Consequently, the wire insertion port turns drawing a large arc, and it is possible to increase the degree of flex R at the displacement portion of the wires.

According to the present invention according to the third aspect, when the turning support member is provided to the vehicle and the slide door is provided at the closed position, the rotary shaft is provided at an end of the turning support member at a side of the open position, and, when the turning support member is provided to the slide door and the slide door is provided at the closed position, the rotary shaft is provided at an end of the turning support member at a side of the closed position. Consequently, the wire insertion port turns drawing a much larger arc, and it is possible to further increase the degree of flex R at the displacement portion of the wires.

According to the present invention according to the fourth aspect, the turning support member includes a guide which guides the rotary shaft along a slide direction of the slide door. Consequently, when, for example, the turning support member is provided to the vehicle, the slide movement of the slide door from the closed position to the open position causes the rotary shaft to move from one end of the guide at the side of the closed position to the other end at the side of the open position, and, a position of the wire insertion port of the turning support member in case where the slide door is provided at the open position moves towards the open position compared to the position of the wire insertion port of the turning support member in case where the slide door is provided at the closed position. Consequently, the wire insertion port turns drawing a large arc, and it is possible to increase the degree of flex R at the displacement portion of the wires. Further, the rotary shaft moves from the one end of the guide at the side of the closed position to the other end at the side of the open position, so that it is possible to reduce the amount of use of wires corresponding to a movement distance of the rotary shaft in the slide direction. Furthermore, it is possible to reduce the amount of use of a wire exterior member (corrugate tube) provided as an exterior for these wires.

### BRIEF DESCRIPTION OF DRAWINGS

FIG. 1 is a plan view that illustrates a wire routing structure according to a first embodiment of the present invention.

FIG. 2 is a plan view that illustrates a modified example of the wire routing structure illustrated in FIG. 1.

FIG. 3 is a plan view that illustrates a wire routing structure according to a second embodiment of the present invention.

FIG. 4 is a perspective view that illustrates enlarged main parts of the wire routing structure illustrated in FIG. 2.

FIG. 5 is a plan view that illustrates a modified example of the wire routing structure illustrated in FIG. 2.

FIGS. 6A to 6C are views that explain a function of the present invention.

FIG. 7 is a plan view that illustrates a state of a conventional power feeding device where a slide door is fully opened.

FIG. 8 is a view that explains a problem of the present invention, and is a plan view that illustrates a state where the slide door makes slide movement from a closed position to an open position.

### DESCRIPTION OF EMBODIMENTS

### First Embodiment

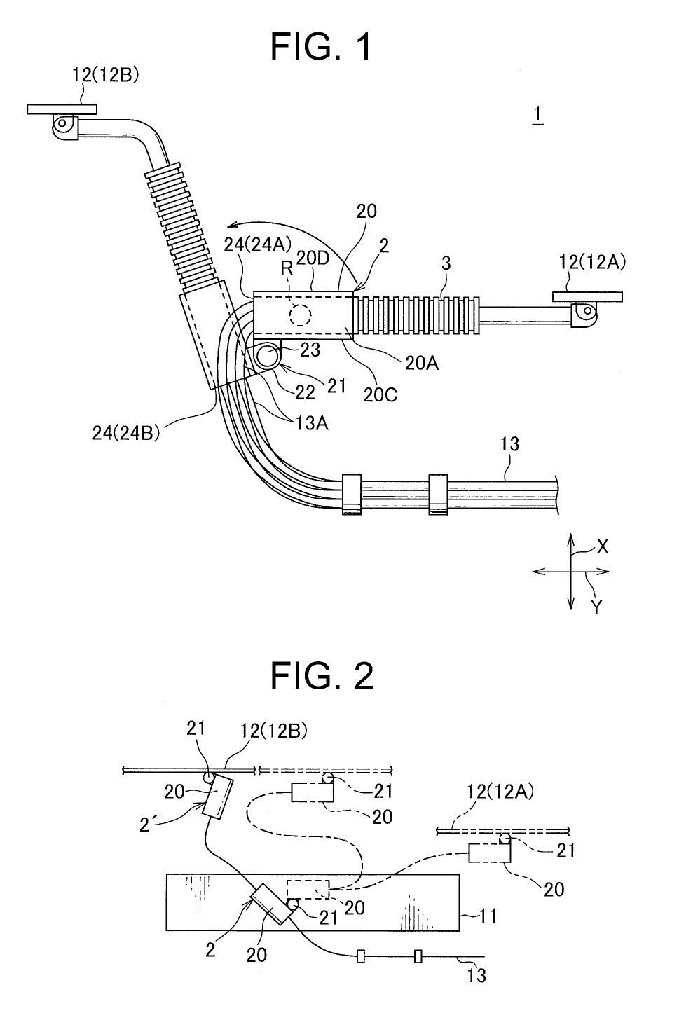

A wire routing structure according to the first embodiment of the present invention will be described below with reference to FIG. 1.

FIG. 1 is a plan view that illustrates the wire routing structure according to the first embodiment of the present invention. As illustrated in FIG. 1, a wire routing structure 1 is a structure which supplies electric power to a slide door 12 which is arranged slidably moveable towards a closed position 12A at which an opening of a vehicle 11 (illustrated in FIG. 2) is fully closed and is arranged slidably moveable towards an open position 12B at which the opening of the vehicle 11 is fully opened. This wire routing structure 1 includes a harness exterior member 2 (turning support member) which turnably supports, in a horizontal direction, wires 13 routed from the vehicle 11 to the slide door 12. This harness exterior member 2 is formed in a cylindrical shape, and retains one end of a corrugate tube 3 in which the wires 13 are inserted.

In this regard, a direction in which the slide door 12 slides is indicated by an arrow Y, and a direction which is orthogonal to this arrow Y direction and in which the slide door 12 and the vehicle 11 oppose when the slide door 12 is provided at an open position, i.e., a vehicle width direction is indicated by an arrow X. The arrow Y direction is a vehicle traveling direction, and a right side in FIG. 1 is a direction in which the slide door 12 fully closes an opening of the vehicle 11 and a left side in FIG. 1 is a direction in which the slide door 12 fully opens the opening of the vehicle 11. An arrow XY direction indicates the horizontal direction. A vertical direction in FIG. 1 is a vertical direction (upper and lower directions).

The slide door 12 is configured to bend at the closed position 12A drawing an arc to move away from a vehicle passenger door (opening), then move backward in the vehicle traveling direction (arrow Y direction) and to move to the open position 12B.

A case where the harness exterior member 2 of the wire routing structure 1 is provided to the vehicle 11 will be described in the present embodiment. In this regard, the harness exterior member 2 is provided at a step of the passenger door (opening) for a vehicle floor. Further, the harness exterior member 2 turnably supports the wires 13 along the horizontal direction (arrow XY direction). One end of the wires 13 is connected to a power supply unit, which is not illustrated, at a front side of the vehicle traveling direction (arrow Y direction), and the other end is connected to the slide door 12. A portion of the wires 13 which is displaced by a turn of the harness exterior member 2 will be referred to as a “displacement portion 13A” below. The displacement portion 13A refers to a portion exposed from the harness exterior member 2 to the vehicle 11 (a lower side in FIG. 1).

The harness exterior member 2 includes a rectangular cylindrical main body 20 including a through-hole (not illustrated) in which the wires 13 are inserted, and a rotary shaft 21 which is provided protruding from this main body 20. The main body 20 includes a pair of first walls 20A which are elongated in the horizontal direction (arrow XY direction), and a pair of second walls 20C and 20D which are elongated in the vertical direction. In this regard, when the slide door 12 is provided at the closed position 12A, the second wall 20C is provided at the vehicle 11 side (the lower side in FIG. 1), and the second wall 20D is provided at the slide door 12 side (an upper side in FIG. 1).

When the slide door 12 is provided at the closed position 12A, the rotary shaft 21 is provided at an end of the second wall 20C at a rear side in the vehicle traveling direction (arrow Y direction). This rotary shaft 21 is provided protruding from the second wall 20C to the vehicle 11, and includes a ring 22 which includes a hole penetrating in the vertical direction, and a shaft 23 which is inserted in this ring 22. The shaft 23 is provided to stand from the step of the vehicle floor in the vertical direction. The ring 22 is inserted onto this shaft 23, and the main body 20 of the harness exterior member 2 is turnably provided about the rotary shaft 21 in the horizontal direction (arrow XY direction) and at the step of the vehicle floor.

Thus, a center of a turn of the harness exterior member 2 is provided at a position displaced (i.e., decentered) from a center axis R (illustrated in FIG. 1) of the wires 13 inserted in the main body 20. Therefore, slide movement of the slide door 12 from the closed position 12A to the open position 12B causes the harness exterior member 2 to turn, and causes a wire insertion port 24A to move towards the open position (wire insertion port 24B). Consequently, a wire insertion port 24 turns drawing a large arc, and it is possible to increase a degree of flex R at the displacement portion 13A of the wires 13. Consequently, when the slide door 12 makes the slide movement, the wires 13 can secure the large degree of flex R at all times.

In addition, in the present embodiment, the rotary shaft 21 of the harness exterior member 2 is provided protruding from the second wall 20C of the main body 20. However, the present invention is not limited to this. The rotary shaft 21 may be provided to a pair of first walls 20A. That is, as long as the rotary shaft 21 is provided at a position displaced from the center axis R (illustrated in FIG. 1) of the wires 13 inserted in the main body 20, the rotary shaft 21 may not protrude from the second wall 20C. Further, the rotary shaft 21 is provided at the end of the second wall 20C at the rear side in the vehicle traveling direction (arrow Y direction). However, the present invention is not limited to this. As long as the rotary shaft 21 is provided at the position displaced from the center axis R (illustrated in FIG. 1) of the wires 13 inserted in the main body 20, the rotary shaft 21 may be provided at any position in the vehicle traveling direction when the slide door 12 is provided at the closed position 12A.

Further, in the present embodiment, the harness exterior member 2 is provided only to the vehicle 11. However, the present invention is not limited to this. The harness exterior member 2 may be provided only to the slide door 12, and may be provided to both of the vehicle 11 and the slide door 12 as illustrated in FIG. 2. In FIG. 2, dashed-two dotted lines indicate that the slide door is provided at the closed position, dashed-dotted lines indicate that the slide door is provided at a half-open position between the closed position and the open position, and solid lines indicate that the slide door is provided at the open position. In this case, the harness exterior member 2 provided to the vehicle 11, and a harness exterior member 2′ provided to the slide door 12 need to have such a disposition relationship that the harness exterior member 2 and the harness exterior member 2′ are reversed in the arrow X direction. In other words, the harness exterior member 2 and the harness exterior member 2′ may have such a disposition relationship that the harness exterior member 2′ provided to the slide door 12 is provided symmetrically with respect to a point around an intermediate point of a portion bent in an S shape at a side closer to the other end side than the harness exterior member 2 provided to the vehicle 11.

### Second Embodiment

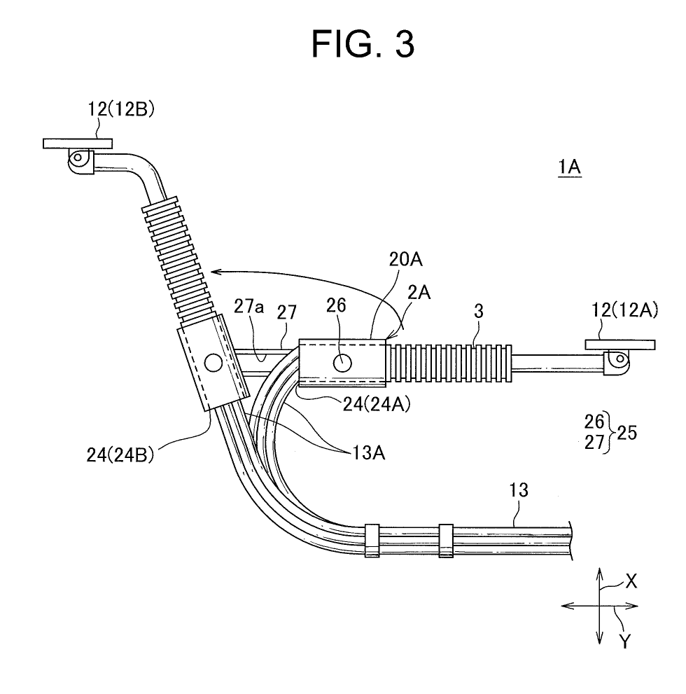

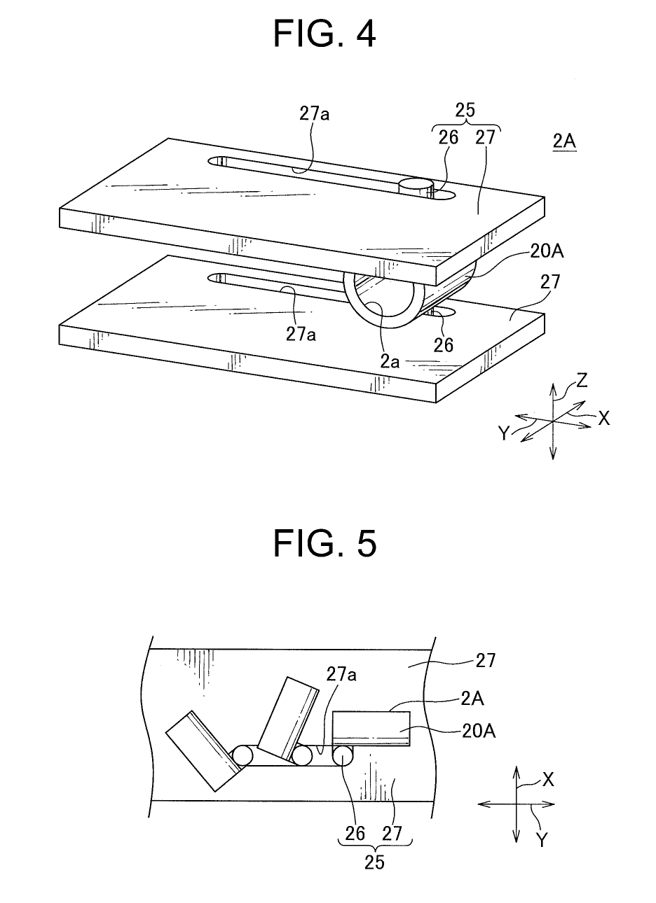

A wire routing structure 1A according to the second embodiment of the present invention will be described below with reference to FIGS. 3 and 4. Members having the same structures and functions as those of a wire routing structure 1 according to the first embodiment will be assigned the same reference numerals, and will not be described. This wire routing structure 1A includes a harness exterior member 2A (turning support member) which turnably supports, in a horizontal direction, wires 13 routed from a vehicle 11 to a slide door 12.

As illustrated in FIGS. 3 and 4, the harness exterior member 2A includes a guide 25 which slides and guides in a slide direction (arrow Y direction) a cylindrical main body 20A including a through-hole 2a (illustrated in FIG. 4) in which the wires 13 are inserted. The guide 25 includes a pair of rotating shafts 26 (rotary shafts) which are provided protruding from the main body 20A in a vertical direction (arrow Z direction in FIG. 4), and a pair of support plates 27 which include elongated holes 27a in which a pair of these rotating shafts 26 are inserted, respectively. Each elongated hole 27a is elongated and provided in the slide direction. A pair of support plates 27 are fixed to a step of a vehicle floor along the horizontal direction (arrow XY direction). A pair of rotating shafts 26 are provided protruding from a position above a center (axis) of the wires 13 inserted in the main body 20A. In addition, FIG. 3 does not illustrate one (upper) support plate 27 of a pair of support plates 27.

According to this harness exterior member 2A, the rotating shafts 26 are inserted in the elongated holes 27a and, consequently, the rotating shafts 26 are guided in the slide direction (arrow Y direction) while being turnably supported by the support plates 27. Thus, the main body 20A of the harness exterior member 2A is turnably provided about the rotating shafts 26 in the horizontal direction (arrow XY direction) and at the step of the vehicle floor.

Thus, the harness exterior member 2A includes a guide 25 which guides the rotating shafts 26 along the slide direction of the slide door 12 (arrow Y direction). When, for example, the harness exterior member 2A is provided to the vehicle 11, slide movement of the slide door 12 from a closed position 12A to an open position 12B causes the rotating shafts 26 to move from one end of the guide 25 at the closed position side to the other end at the open position side. A position of a wire insertion port 24B of the harness exterior member 2A in case where the slide door 12 is provided at the open position 12B moves towards the open position compared to the position of the wire insertion port 24A of the harness exterior member 2A in case where the slide door 12 is provided at the closed position 12A. Consequently, the wire insertion port 24 turns drawing a large arc, and it is possible to increase a degree of flex Rat a displacement portion 13A of the wires 13. Further, the rotating shafts 26 move from the one end of the guide 25 at the closed position side to the other end at the open position side, so that it is possible to reduce the amount of use of the wires 13 corresponding to a movement distance of the rotating shafts 26 in the slide direction (arrow Y direction). Furthermore, it is possible to reduce the amount of use of a wire exterior member (corrugate tube) provided as an exterior for the wires 13.

In addition, in the present embodiment, the support plates 27 of the harness exterior member 2A include the elongated holes 27a. However, the present invention is not limited to this. Grooves in which the rotating shafts 26 are inserted may be provided instead of the elongated holes 27a.

Further, in the present embodiment, the rotating shafts 26 are provided protruding from a position above the center (axis) of the wire 13 inserted in the main body 20A. However, the present invention is not limited to this. As illustrated in FIG. 5, the rotating shafts 26 may be provided at a position displaced from the center (axis) of the wires 13 inserted in the main body 20A. In this case, when the slide door 12 is provided at the closed position 12A, the rotating shafts 26 may be provided protruding from the main body 20A to the vehicle 11, and the rotating shafts 26 may be provided at ends of the main body 20A at the opening position side. That is, the harness exterior member 2A needs to include the guide 25 which guides the rotating shafts 26 along the slide direction of the slide door 12 (arrow Y direction) wherever the rotating shafts 26 are provided at any positions. In addition, FIG. 5 does not illustrate one (upper) support plate 27 of a pair of support plates 27.

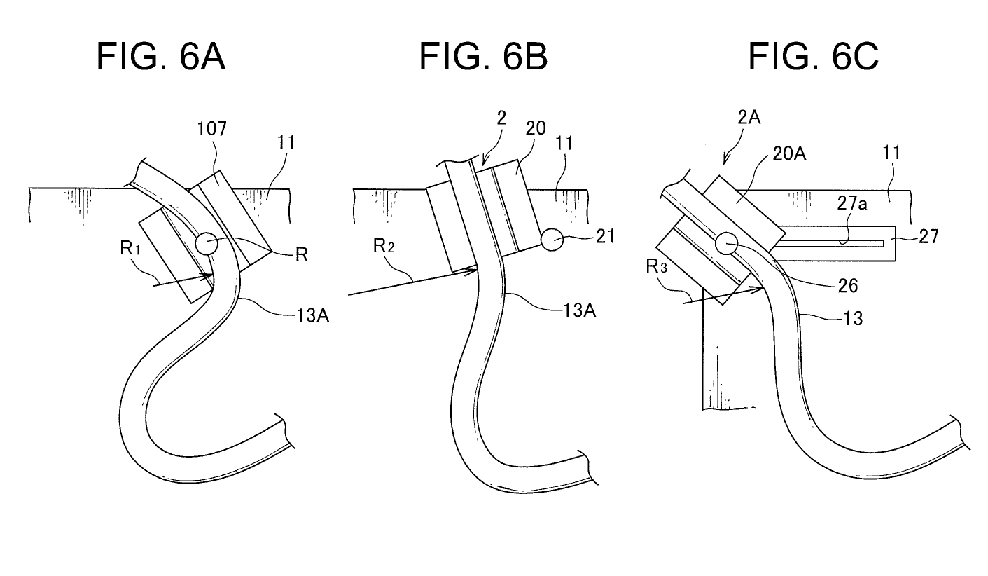

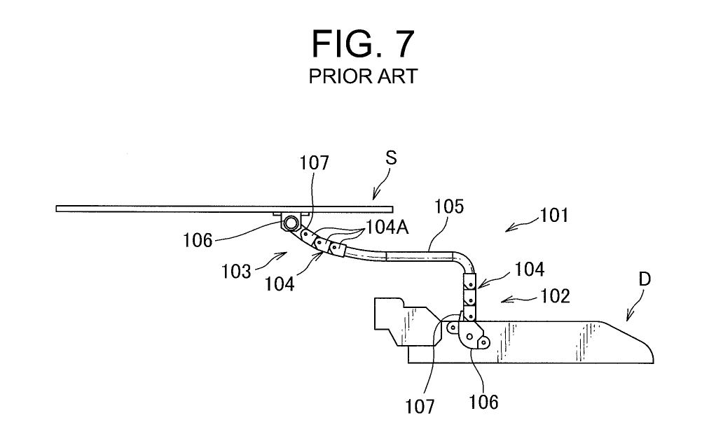

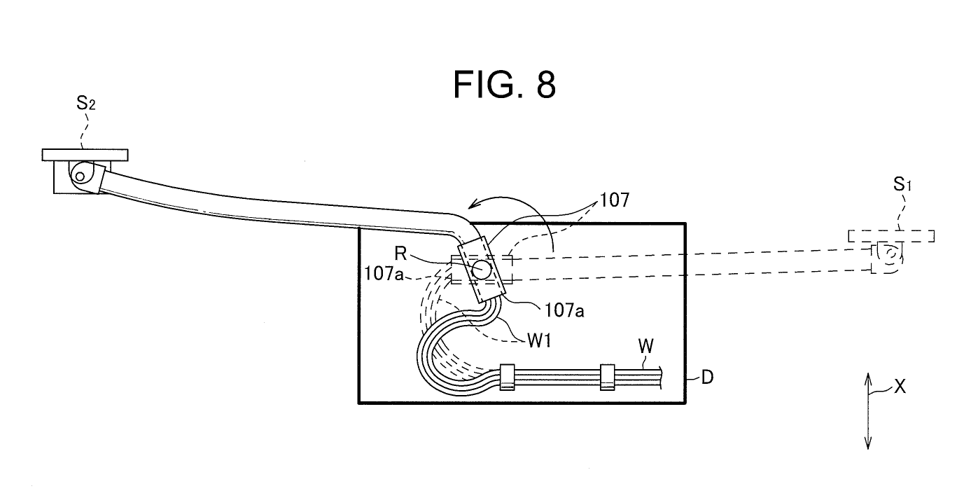

Slide movement of this slide door 12 from the closed position 12A to the open position 12B bends the displacement portion 13A of the wires 13 supported by the harness exterior members 2 and 2A. FIGS. 6A to 6C illustrate a result obtained by measuring for the flex (displacement) of the wires 13 a degree of flex R (flex radius) caused by slide movement of the slide door 12. As illustrated in FIG. 6A, it has been found that, when a shaft R of an inner member 107 (harness exterior member) is provided at a position above the center axis of the wires 13 supported by the inner member 107, the wires 13 are bent at the degree of flex R1 (flex radius) of 20 mm. Meanwhile, as illustrated in FIG. 6B, it has been found that, when a degree of flex is measured by using a harness exterior member 2 according to the first embodiment, i.e., when a rotary shaft 21 is provided at a position displaced from the center axis of the wires 13 inserted in a main body 20, and the slide door 12 is provided at the closed position 12A, the rotary shaft 21 is provided protruding from the main body 20 towards the vehicle 11, and, when the rotary shaft is provided at an end at the opening position side, the wires 13 are bent at a degree of flex R2 (flex radius) of 150 mm. Further, as illustrated in FIG. 6C, it has been found that, when a degree of flex is measured by using the harness exterior member 2A according to the second embodiment, i.e., when the rotating shafts 26 are guided by the guide 25 along the slide direction (arrow Y direction) of the slide door 12, the wires 13 are bent at a degree of flex R3 (flex radius) of 50 mm.

In view of the above measurement result, it has been confirmed that, when the degree of flex is measured by using the harness exterior member 2 according to the first embodiment and when the degree of flex is measured by using the harness exterior member 2A according to the second embodiment, the wires 13 bent by movement of the slide door 12 can secure the large degree of flex R at all times. Consequently, it is possible to improve a flex life of the wires 13. Further, the wires 13 can secure the large degree of flex R at all times, so that it is possible to reduce a displacement amount of the wires 13 during movement of the slide door 12 from the closed position 12A to the open position 12B and, consequently, to reduce a force for causing the slide movement of the slide door 12.

In addition, the above-described embodiments are exemplary embodiments of the present invention, and the present invention is not limited to the above-described embodiments. That is, the above-described embodiments can be variously modified and carried out without departing from a spirit of the present invention.

### REFERENCE SIGNS LIST

1,1A Wire routing structure
2,2A Harness exterior member (Turning support member)
11 Vehicle
12 Slide door
13 Wire
21 Rotary shaft
25 Guide
26 Rotating shaft (Rotary shaft)

1. A wire routing structure for routing a wire that supplies electric power to a slide door arranged slidably movable towards a closed position at which an opening of a vehicle is fully closed, and is also arranged slidably movable towards an open position at which the opening of the vehicle is fully opened, the wire routing structure comprising:
a turning support member which is provided to at least one of the vehicle and the slide door, and is designed to displaceably support the wire by turning in a horizontal plane,
wherein, when the turning support member is provided to the vehicle, slide movement of the slide door from the closed position to the open position causes the turning support member to turn about a rotary shaft of the turning support member so as to move closer to the open position than the rotary shaft, and, when the slide door is at the closed position, the rotary shaft is provided at a position displaced toward the vehicle with respect to center axis of the wire which is supported by the turning support member in a vehicle proceeding direction, while,
when the turning support member is provided to the slide door, the slide movement of the slide door from the closed position to the open position causes the turning support member to turn about the rotary shaft of the turning support member so as to move closer to the closed position than the rotary shaft, and, when the slide door is at the closed position, the rotary shaft is provided at a position displaced toward the slide door with respect to the center axis of the wire which is supported by the turning support member in the vehicle proceeding direction.

2. The wire routing structure according to claim 1, wherein
when the turning support member is provided to the vehicle and the slide door is positioned at the closed position, the rotary shaft is provided at an end of the turning support member at a side of the open position, and
when the turning support member is provided to the slide door and the slide door is positioned at the closed position, the rotary shaft is provided at an end of the turning support member at a side of the closed position.

3. The wire routing structure according to claim 1, wherein the turning support member includes a guide which guides the rotary shaft along a slide direction of the slide door.

4. The wire routing structure according to claim 2, wherein the turning support member includes a guide which guides the rotary shaft along a slide direction of the slide door.
